(19) United States
(12) Patent Application Publication
(10) Pub. No.: US 2026/0040105 A1
(43) Pub. Date: Feb. 5, 2026

(54) METRIC AND METRIC ALGORITHM SHARING

(71) Applicant: Cisco Technology, Inc., San Jose, CA (US)

(72) Inventors: Mark GRAYSON, Maidenhead (GB); Srinath GUNDAVELLI, San Jose, CA (US); Bart A. BRINCKMAN, Nevele (BE)

(21) Appl. No.: 19/280,946

(22) Filed: Jul. 25, 2025

Related U.S. Application Data
(60) Provisional application No. 63/678,891, filed on Aug. 2, 2024.

(51) Int. Cl. H04W 24/08

(52) U.S. Cl. CPC H04W 24/08

(57) ABSTRACT

Described herein is a network that shares metrics and the algorithms used to determine the values of metrics. A wireless device includes one or more memories and one or more processors communicatively coupled to the one or more memories. The one or more processors, individually or collectively, perform an operation that includes calculating, using a first algorithm, a first value of a first metric for a wireless medium in a network, adding, to a message, the first value of the first metric, adding, to the message, an indication of the first algorithm used to calculate the first value of the first metric, and transmitting the message to report the first value of the first metric and the first algorithm.

### CROSS-REFERENCE TO RELATED APPLICATIONS

This application claims benefit of co-pending U.S. provisional patent application Ser. No. 63/678,891 filed Aug. 2, 2024. The aforementioned related patent application is herein incorporated by reference in its entirety.

### TECHNICAL FIELD

Embodiments presented in this disclosure generally relate to wireless networks. More specifically, embodiments disclosed herein relate to networks that share metrics and metric algorithms.

### BACKGROUND

Wireless networks (e.g., Wi-Fi networks, cellular networks, mobile networks, etc.) facilitate wireless communications between devices. Different components and devices on a network may use different algorithms and parameters to calculate the values of metrics related to the network. In existing networks, the components and devices may report these values to each other, or to other network devices, but these components and devices may each assume that a reported value for a metric was generated in a specific way, for example in the same way that the components or devices would generate the value for the metric, which may be an incorrect assumption. As a result, it may be incorrect or problematic for the components or devices to make determinations or perform actions based on the reported value.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example computer system, access point, or device in the system of FIG. 1A.

FIG. 2A illustrates an example operation in the system of FIG. 1A.

FIG. 2B illustrates an example message.

FIG. 3 illustrates an example operation performed in the system of FIG. 1A.

FIG. 4 is a flowchart of an example method performed by the system of FIG. 1A.

FIG. 5 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that shares metrics and the algorithms used to determine the values of metrics. According to an embodiment, a wireless device includes one or more memories and one or more processors communicatively coupled to the one or more memories. The one or more processors, individually or collectively, perform an operation that includes calculating, using a first algorithm, a first value of a first metric for a wireless medium in a network, adding, to a message, the first value of the first metric, adding, to the message, an indication of the first algorithm used to calculate the first value of the first metric, and transmitting the message to report the first value of the first metric and the first algorithm.

According to another embodiment, a method includes calculating, by a wireless device and using a first algorithm, a first value of a first metric for a wireless medium in a network, adding, by the wireless device and to a message, the first value of the first metric, adding, by the wireless device and to the message, an indication of the first algorithm used to calculate the first value of the first metric, and transmitting, by the wireless device, the message to report the first value of the first metric and the first algorithm.

According to another embodiment, an apparatus includes one or more memories and one or more processors communicatively coupled to the one or more memories. The one or more processors, individually or collectively, perform an operation that includes receiving, from a first device, a first message indicating (i) a first value of a first metric for a wireless medium in a network and (ii) a first algorithm used to calculate the first value of the first metric and receiving, from a second device, a second message indicating (i) a second value of the first metric and (ii) a second algorithm used to calculate the second value of the first metric. The first algorithm is different from the first algorithm. The operation also includes normalizing, based on the first algorithm and the second algorithm, the first value and the second value, selecting the first device based on comparing the normalized first value and the normalized second value, and transmitting a message to the first device based on selecting the first device.

### EXAMPLE EMBODIMENTS

The present disclosure describes a network that shares the values of metrics and the algorithms used to determine or calculate those values. Generally, a device in the network (e.g., a computer system, an access point, a client device, etc.) may take measurements various metrics (e.g., metrics related to the transmission medium). The device may then generate a message that reports the measured values of the metrics. The device may further include in that message the algorithms and parameters used to measure or calculate those metrics. The device may then transmit the message to other components in the system. A receiving component may use the information about the algorithms and parameters to normalize the values of the metrics with metric values from other devices that may have used other algorithms and parameters. For example, the receiving component may apply a transformation (e.g., a mathematical transformation, data transformation, etc.) to the values of the metrics to account for the device using different algorithms and parameters to calculate the values of the metrics relative to the other devices. The receiving component may also apply one or more transformations to the metrics such that the values of the metrics may be directly compared to the metric values from the other devices. By applying the transformations, the normalized values of the metrics from all devices may be directly compared with each other.

In certain embodiments, the network provides several technical advantages. For example, the network may normalize metric values based on the algorithms used to determine the metric values, which may allow more accurate decisions to be made on the network. As another example, because more accurate decisions may be made on the network, the operation and efficiency of the network may be improved.

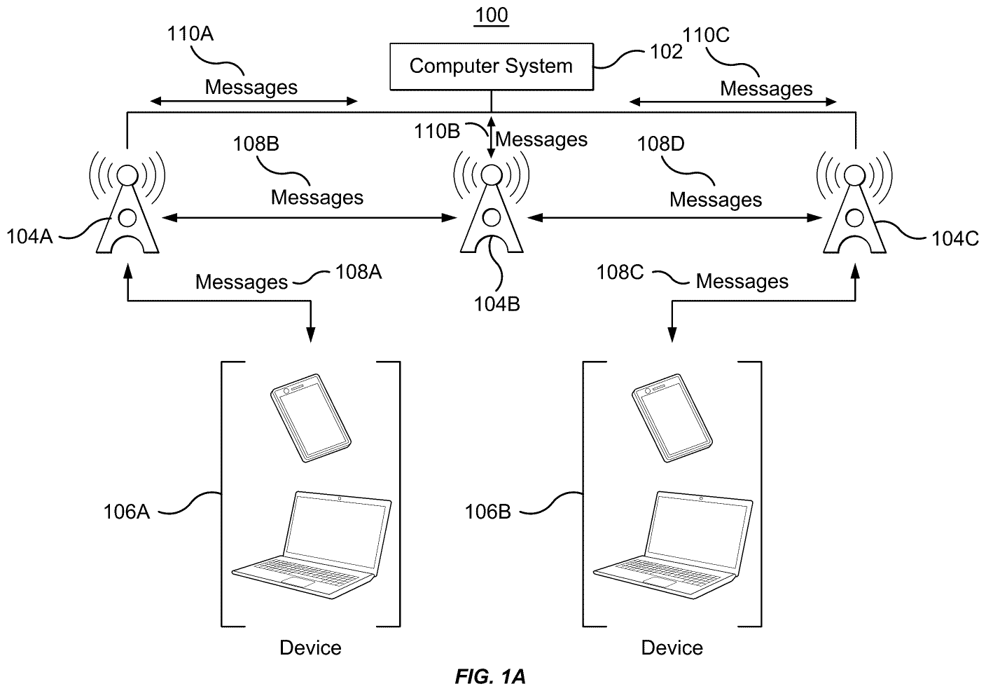

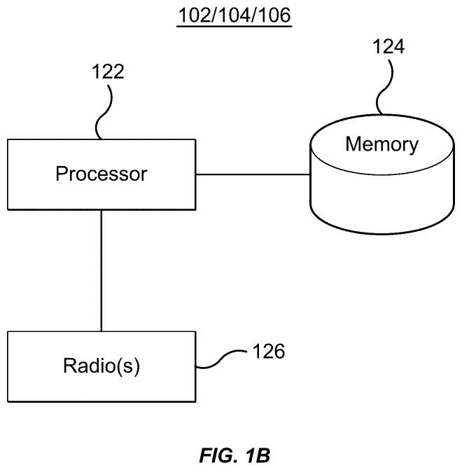

FIG. 1A illustrates an example system 100. As seen in FIG. 1A, the system 100 includes a computer system 102, access points 104 (e.g., access points 104A, 104B, and 104C), and devices 106 (e.g., devices 106A and 106B). Generally, the access points 104 and devices 106 may calculate the values of certain metrics (e.g., signal strength, channel utilization, etc.) and report these values to other components in the system 100. The access points 104 and devices 106 may also report the algorithms and parameters used to determine the values of the metrics, which allows the receiving components to determine how to normalize the calculated values from different access points 104 and devices 106.

The computer system 102 may manage or oversee the operations of the access points 104. For example, the computer system 102 may be a network controller or server that tracks the operations and performance of the access points 104. The computer system 102 may attempt to optimize the performance of the system 100 by adjusting the transmission characteristics of the access points 104. For example, the computer system 102 may instruct the access points 104 what frequency bands, channels, transmission powers, etc. to use.

An access point 104 may be a network device that facilitates wireless communication (e.g., Wi-Fi communication) in the system 100. A device 106 connects to the access point 104, and the access point 104 may facilitate communication to and from the device 106. For example, the access point 104 may receive messages from the device 106 and direct those messages towards their destination. As another example, the access point 104 may receive messages intended for the device 106 and direct those messages to the device 106. The access point 104 may also exchange messages with other access points 104 and the computer system 102.

The device 106 may be any suitable device that wirelessly connects to an access point 104. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment usable by the user. The device 106 may include a hardware processor, memory, or circuitry configured to perform any of the functions or actions of the device 106 described herein. For example, a software application designed using software code may be stored in the memory and executed by the processor to perform the functions of the device 106.

Generally, the access points 104 and the devices 106 in the system 100 may measure various aspects of the transmission medium and calculate the values of various metrics using those measurements. For example, the access points 104 and the devices 106 may measure and calculate signal strength, transmission power, channel utilization, or any other metric. The access points 104 and the devices 106 may communicate messages to each other to report the values of the metrics. In the example of FIG. 1A, the access point 104A and the device 106A exchange messages 108A to report the values of metrics. The access point 104A and the access point 104B exchange messages 108B to report the values of metrics. The access point 104C and the device 106B exchange messages 108C to report the values of metrics. The access point 104B and the access point 104C exchange messages 108D to report the values of metrics. The access points 104 may communicate messages with the computer system 102. In the example of FIG. 1A, the access point 104A and the computer system 102 exchange messages 110A. The access point 104B and the computer system 102 exchange message 110B. The access point 104C and the computer system 102 exchange message 110C.

Additionally, the access points 104 and the devices 106 indicate, in the messages, the algorithms or parameters used to calculate the reported values of the metrics. These algorithms and parameters may indicate the processes, formulas, assumptions, constants, etc. used to calculate the reported values of the metrics. By reporting the algorithms and parameters, a component receiving the reported values of the metrics may determine how the values were determined. The component may then normalize the reported values with values reported by other access points 104 or devices 106, which may have used different algorithms and parameters to calculate the values. In this manner, the component may accurately or correctly compare values for metrics from different access points 104 or devices 106 that may have calculated the values differently.

FIG. 1B illustrates an example computer system 102, access point 104, or device 106 of the system 100 of FIG. 1A. As seen in FIG. 1B, the computer system 102, the access point 104, and device 106 include a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the computer system 102, the access point 104, or the device 106. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the computer system 102, the access point 104, or the device 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the computer system 102, the access point 104, or the device 106 may use one or more of the radios 126 for Wi-Fi communications. The computer system 102, the access point 104, or the device 106 may use one or more of the radios 126 to transmit messages and one or more of the radios 126 to receive messages. The computer system 102, the access point 104, or the device 106 may include any number of radios 126 to communicate using any number of communication technologies.

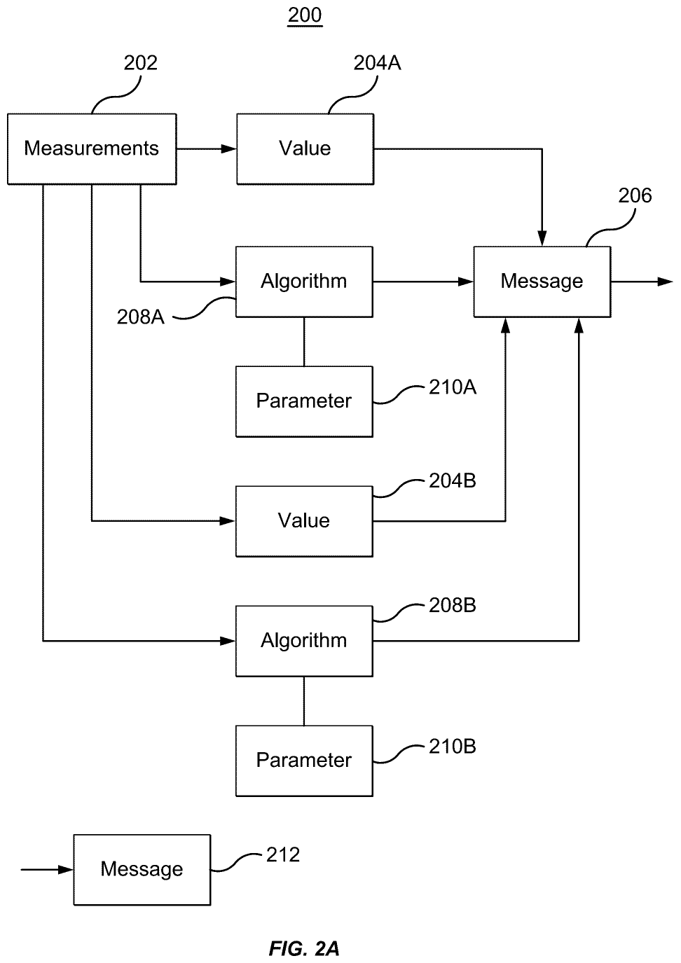

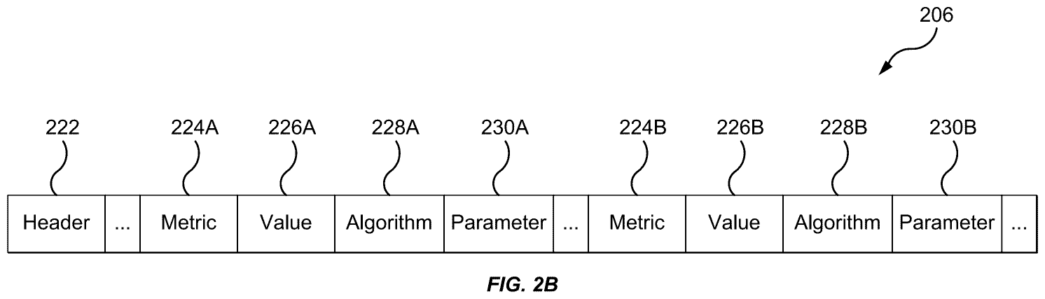

FIG. 2A illustrates an example operation 200 in the system 100 of FIG. 1A. Generally, a wireless device (e.g., the access point 104A or the device 106A shown in FIG. 1A) performs the operation 200. By performing the operation 200, the wireless device calculates and reports values for metrics related to the wireless medium.

The wireless device begins by taking one or more measurements 202 of the wireless medium. The wireless device may use a radio of the wireless device to take the measurements 202. For example, the wireless device may measure an amount of time that a channel is utilized. As another example, the wireless device may measure signal strength of messages communicated over the wireless medium.

The wireless device may then calculate values for one or more metrics using the measurements 202. For example, the wireless device may calculate a channel utilization or average channel utilization using the measurements 202. As another example, the wireless device may calculate a received signal strength indicator (RSSI) value using the measurements 202. In the example of FIG. 2A, the wireless device calculates a value 204A for a first metric and a value 204B for a second metric.

The wireless device may be programmed or set up to calculate the values for the metrics in a specific way. For example, the wireless device may use certain processes, formulas, constants, variables, assumptions, etc. to calculate the values for the metrics. These processes, formulas, constants, variables, assumptions, etc. may be different from the processes, formulas, constants, variables, assumptions, etc. used by other wireless devices in the network to calculate values for the same metrics. As a result, different wireless devices in the network may determine different values for the same metrics.

To allow an accurate comparison between values calculated by different wireless devices, the wireless device may report the values of the metrics along with the algorithms and parameters used by the wireless device to calculate the values of the metrics. In the example of FIG. 2A, the wireless device may have used the algorithm 208A and the parameters 210A to calculate the value 204A, and the wireless device may have used the algorithm 208B and the parameters 210B to calculate the values 204B. The wireless device generates a message 206 to report the values 204A and 204B, algorithms 208A and 208B, and parameters 210A and 210B. For example, the wireless device may add, to the message 206, indications of the values 204A and 204B, the algorithms 208A and 208B, and the parameters 210A and 210B. The wireless device may then communicate the message 206 to other components or wireless devices in the network to report the values 204A and 204B, algorithms 208A and 208B, and parameters 210A and 210B.

As an example, the wireless device may calculate and report average channel utilization, but different wireless devices (e.g., wireless devices from different manufacturers or designers) may use a different time period to calculate the average channel utilization (which may also be referred to as an averaging period). For example, some wireless devices may average measured channel utilization over a shorter time period, while other wireless devices average over a longer time period. By including the time period in the message 206, a receiving component may more accurately compare the average channel utilizations reported by different wireless devices.

As another example, the wireless device may calculate and report a noise floor attributed, but different wireless devices may calculate noise floor in different ways. For example, some wireless devices may use different constants or variables (e.g., TUNE_CALIBRATION_INTERVAL_SHORT and NF_CAL_HIST_MAX, which may control the number of samples and the time period over which the median of the samples is determined) when calculating the noise floor. Different wireless devices may set these constants or variables to different values, which results in different noise floor calculations. By including the values of these constants or variables in the message 206, a receiving component may more accurately compare the noise floor reported by different wireless devices.

As another example, the wireless device may calculate and report RSSI, but different wireless devices may calculate RSSI in different ways. For example, some wireless devices may calculate RSSI using an exponential weighted moving average algorithm, where the algorithm uses two variables representing a weight factor. One variable may represent a weight depth, and the other variable may represent a number of right shifts for fixed point arithmetic. As an example, a weight depth of 10 with 8 right shifts represents a weight of 1/256 or 1/(2 8). Different wireless devices may set these variables to different values, which results in different RSSI calculations. By including the values of these variables in the message 206, a receiving component may more accurately compare the RSSIs reported by different wireless devices.

In some embodiments, the component that receives the message 206 may normalize and compare the reported values of the metrics with the values of metrics reported by other wireless devices in the network. The component may then make determinations or selections based on the comparison. For example, the component may select the wireless device to perform certain communications based on better performance than the other wireless devices. The component may communicate a message 212 to the wireless device to indicate that the wireless device has been selected based on the reported values. The wireless device may respond to the message 212 by performing an action that the wireless device was selected to perform.

FIG. 2B illustrates an example message 206. Generally, the message 206 reports the values for different metrics along with the algorithms and parameters used to calculate those values.

As seen in FIG. 2B, the message 206 includes a header 222 that includes information about the message 206. For example, the header 222 may indicate a length of the message 206 as well as the positions in the message 206 where certain metric values are reported.

The message 206 also includes sections that report the values of metrics and the algorithms and parameters used to calculate those values. As seen in FIG. 2B, the message 206 includes a field 224A that identifies a first metric. The message 206 also includes a field 226A that indicates a value for the first metric. Additionally, the message 206 includes fields 228A and 230A that indicate the algorithm or parameter used to calculate the value. In some instances, if the algorithm does not use a configurable parameter, then the field 230A may not be included in the message 206 or the field 230A may be set as a null value or a random value.

The message 206 also includes a field 224B that identifies a second metric. The message 206 also includes a field 226B that indicates a value for the second metric. Additionally, the message 206 includes fields 228B and 230B that indicate the algorithm or parameter used to calculate the value. In some instances, if the algorithm does not use a configurable parameter, then the field 230B may not be included in the message 206 or the field 230B may be set as a null value or a random value.

The message 206 shown in FIG. 2B is exemplary. A wireless device may add any number of fields to the message 206 to report any number of metric values, algorithms, and parameters. Additionally, the fields in the message 206 may be arranged in any order or sequence. Moreover, some fields may be combined with other fields, and some fields may be split or divided into multiple fields.

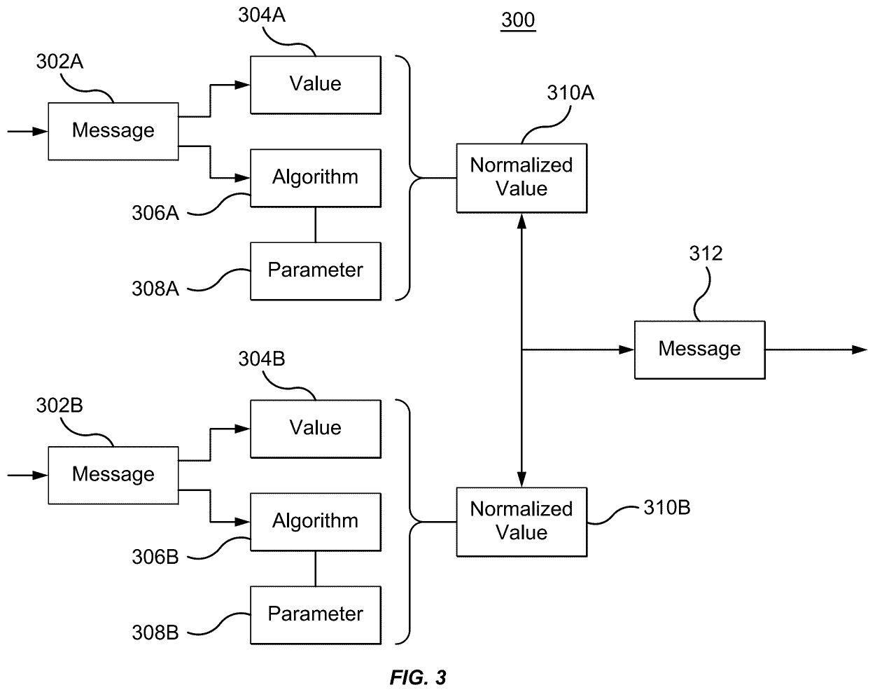

FIG. 3 illustrates an example operation 300 performed in the system 100 of FIG. 1A. Generally, a device (e.g., the computer system 102, the access point 104A, or the device 106A shown in FIG. 1A) performs the operation 300. By performing the operation 300, the device receives reported values for metrics from different wireless devices (e.g., other access points or devices) and compares those reported values.

The device begins by receiving messages from other wireless devices. The messages may include values for metrics calculated by those other wireless devices. In the example of FIG. 3, the device receives a message 302A from a first wireless device and a message 302B from a second wireless device. Each message 302A and 302B indicates a value for a metric. The message 302A indicates a value 304A for the metric as calculated by the first wireless device, and the message 302B indicates a value 304B for the metric as calculated by the second wireless device.

Additionally, the messages also indicate the algorithms or parameters used to calculate those values. The message 302A indicates an algorithm 306A and a parameter 308A that the first wireless device used to calculate the value 304A for the metric. The message 302B indicates an algorithm 306B and a parameter 308B that the second wireless device used to calculate the value 304B for the metric. The device may determine from the messages 302A and 302B that the first wireless device and the second wireless device used different algorithms or parameters to calculate the values 304A and 304B for the metric.

The device may normalize the values 304A and 304B using information about the algorithms and parameters indicated by the messages 302A and 302B. Normalizing the value 304A produces the normalized value 310A, and normalizing the value 304B produces the normalized value 310B. For example, the normalized values 310A and 310B may be what the first wireless device and the second wireless device would have determined for the values 304A and 304B had the first wireless device and the second wireless device used the same algorithm and parameter to calculate the values 304A and 304B. As another example, the normalized values 310A and 310B may be transformed versions of the values 304A and 304B that are in the same space (e.g., dimensional space, unit space, numerical space, vector space, matrix space, etc.), and are thus able to be mathematically compared.

The device may compare the normalized values 310A and 310B and select one of the first wireless device or the second wireless device based on the comparison. For example, the device may select the first wireless device is the normalized values 310A and 310B show that the first wireless device has a better RSSI than the second wireless device. The device may then generate a message 312 indicating that the first wireless device has been selected. The device may communicate the message 312 to the first wireless device to indicate to the first wireless device that the first wireless device has been selected.

In some instances, the device does not normalize every value reported in the messages. For example, the device may normalize the value 304A to produce the normalized value 310A. The normalized value 310A may be what the first wireless device would have calculated for the value 304A had the first wireless device used the algorithm 306B and the parameter 308B to calculate the value 304A. The device may then compare the normalized value 310A to the value 304B (thereby avoiding normalizing the value 304B).

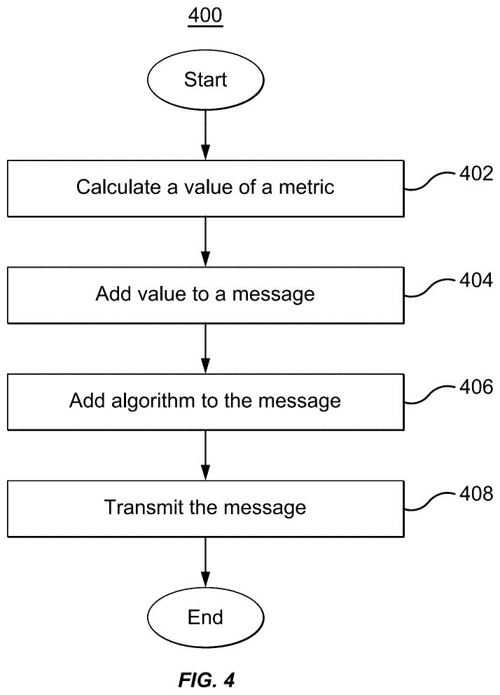

FIG. 4 is a flowchart of an example method 400 performed by the system 100 of FIG. 1A. In certain embodiments, a wireless device (e.g., the access point 104A or the device 106A shown in FIG. 1A) performs the method 400. By performing the method 400, the wireless device calculates and reports values for metrics related to the wireless medium.

At 402, the wireless device calculates the value of a metric. The wireless device may take measurements of a wireless medium and use the measurements to calculate the value of the metric. Additionally, the wireless device may use an algorithm (e.g., a process, formula, etc.) and a parameter (e.g., a variable, constant, assumption, etc.) to calculate the value of the metric from the measurements. As an example, the wireless device may calculate a channel utilization, a noise floor, a RSSI, etc.

At 404, the wireless device adds the value to a message. The wireless device may also add an indication of the metric to the message. At 406, the wireless device may also add an indication of the algorithm to the message to indicate that the algorithm was used to calculate the value. In some instances, the wireless device may also add an indication of the parameter to the message to indicate that the parameter was used to calculate the value.

At 408, the wireless transmits the message to another component in the network. By transmitting the message, the wireless device reports the calculated value of the metric and the algorithm or parameter used to calculate the value.

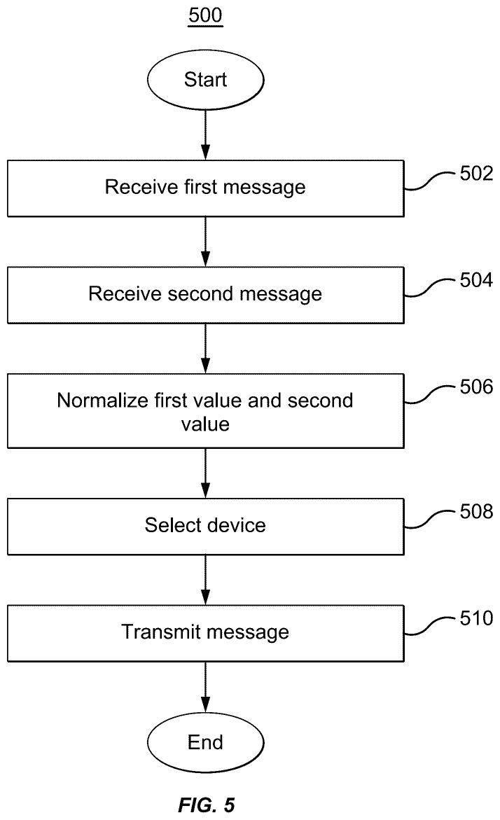

FIG. 5 is a flowchart of an example method 500 performed by the system 100 of FIG. 1A. In certain embodiments, a device (e.g., the computer system 102, the access point 104A, or the device 106A shown in FIG. 1A) performs the method 500. By performing the method 500, the device receives reported values for metrics from different wireless devices (e.g., other access points or devices) and compares those reported values.

At 502, the device receives a first message from a first wireless device. The first message may indicate a value of a metric calculated by the first wireless device. Additionally, the first message may indicate an algorithm or parameter that the first wireless device used to calculate the value of the metric. At 504, the device receives a second message from a second wireless device. The second wireless message may indicate a value of the metric calculated by the second wireless device. Additionally, the second message may indicate an algorithm or parameter that the second wireless device used to calculate the value of the metric. The first wireless device may have used a different algorithm or parameter than the second wireless device.

At 506, the device normalizes the first value or the second value. By normalizing the first value or the second value, the wireless device may apply a transformation to the first value or the second value that may bring the first value or the second value to the same comparison space (e.g., dimensional space, unit space, numerical space, vector space, matrix space, etc.), which may allow the normalized values to be compared with each other. In some instances, the device normalizes only one of the first value or the second value. The device may then compare the normalized values.

At 508, the device selects the first wireless device or the second wireless device based on comparing the normalized values (or a normalized value with a reported value). For example, the comparison may reveal which of the first wireless device or the second wireless device is exhibiting better performance. The device may then select the first wireless device or the second wireless device that is performing better.

At 510, the device transmits a message to the selected device. For example, if the first wireless device was selected, the device may transmit the message to the first wireless device to indicate to the first wireless device that the first wireless device has been selected to perform an operation. The first wireless device may then perform the operation.

In some embodiments, the device compares one or more of the normalized values with a threshold. For example, by normalizing the first value based on the algorithm and parameter used to determine the first value, the device may transform the first value in a way that allows the first value to be compared against the threshold. The device may then take a responsive action (e.g., selecting a wireless device) based on whether the normalized first value falls below or exceeds the threshold. As a result, the device may compare normalized values against thresholds, rather than against each other.

In summary, a network shares the values of metrics and the algorithms used to determine or calculate those values. Generally, a device in the network (e.g., a computer system, an access point, a client device, etc.) may take measurements various metrics (e.g., metrics related to the transmission medium). The device may then generate a message that reports the measured values of the metrics. The device may further include in that message the algorithms and parameters used to measure or calculate those metrics. The device may then transmit the message to other components in the system. A receiving component may use the information about the algorithms and parameters to normalize the values of the metrics with measured metric values from other devices that may have used other algorithms and parameters.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless device comprising:
one or more memories; and
one or more processors communicatively coupled to the one or more memories, the one or more processors configured to, individually or collectively, perform an operation comprising:
calculating, using a first algorithm, a first value of a first metric for a wireless medium in a network;
adding, to a message, the first value of the first metric;
adding, to the message, an indication of the first algorithm used to calculate the first value of the first metric; and
transmitting the message to report the first value of the first metric and the first algorithm.

2. The wireless device of claim 1, wherein calculating the first value of the first metric uses a parameter of the first algorithm and wherein the operation further comprises adding, to the message, the parameter.

3. The wireless device of claim 2, wherein the first metric is a channel utilization of the wireless medium and wherein the parameter is an averaging period used in calculating the channel utilization.

4. The wireless device of claim 2, wherein the first metric is a received signal strength indicator and wherein the parameter is at least one of a weight depth or a number of right shifts for fixed point arithmetic.

5. The wireless device of claim 2, wherein the first metric is a noise floor of the network and wherein the parameter is at least one of a number of samples or a period of time.

6. The wireless device of claim 1, wherein the operation further comprises:
calculating, using a second algorithm, a second value of a second metric for the wireless medium;
adding, to the message, the second value of the second metric; and
adding, to the message, an indication of the second algorithm used to calculate the second value of the second metric.

7. The wireless device of claim 1, wherein the operation further comprises receiving a message indicating that the wireless device has been selected based on the first value of the first metric.

8. A method comprising:
calculating, by a wireless device and using a first algorithm, a first value of a first metric for a wireless medium in a network;
adding, by the wireless device and to a message, the first value of the first metric;
adding, by the wireless device and to the message, an indication of the first algorithm used to calculate the first value of the first metric; and
transmitting, by the wireless device, the message to report the first value of the first metric and the first algorithm.

9. The method of claim 8, wherein calculating the first value of the first metric uses a parameter of the first algorithm and wherein the method further comprises adding, to the message, the parameter.

10. The method of claim 9, wherein the first metric is a channel utilization of the wireless medium and wherein the parameter is an averaging period used in calculating the channel utilization.

11. The method of claim 9, wherein the first metric is a received signal strength indicator and wherein the parameter is at least one of a weight depth or a number of right shifts for fixed point arithmetic.

12. The method of claim 9, wherein the first metric is a noise floor of the network and wherein the parameter is at least one of a number of samples or a period of time.

13. The method of claim 8, further comprising:
calculating, using a second algorithm, a second value of a second metric for the wireless medium;
adding, to the message, the second value of the second metric; and
adding, to the message, an indication of the second algorithm used to calculate the second value of the second metric.

14. The method of claim 8, further comprising receiving a message indicating that the wireless device has been selected based on the first value of the first metric.

15. An apparatus comprising:
one or more memories; and
one or more processors communicatively coupled to the one or more memories, the one or more processors configured to, individually or collectively, perform an operation comprising:
receiving, from a first device, a first message indicating (i) a first value of a first metric for a wireless medium in a network and (ii) a first algorithm used to calculate the first value of the first metric;
receiving, from a second device, a second message indicating (i) a second value of the first metric and (ii) a second algorithm used to calculate the second value of the first metric, wherein the first algorithm is different from the first algorithm;
normalizing, based on the first algorithm and the second algorithm, the first value and the second value;
selecting the first device based on comparing the normalized first value and the normalized second value; and
transmitting a message to the first device based on selecting the first device.

16. The apparatus of claim 15, wherein the first message further indicates a parameter of the first algorithm used to calculate the first value.

17. The apparatus of claim 16, wherein the first metric is a channel utilization of the wireless medium and wherein the parameter is an averaging period used in calculating the channel utilization.

18. The apparatus of claim 16, wherein the first metric is a received signal strength indicator and wherein the parameter is at least one of a weight depth or a number of right shifts for fixed point arithmetic.

19. The apparatus of claim 16, wherein the first metric is a noise floor of the network and wherein the parameter is at least one of a number of samples or a period of time.

20. The apparatus of claim 15, wherein the operation further comprises comparing the normalized first value to a threshold.
